(19) United States
(12) Patent Application Publication
(10) Pub. No.: US 2016/0380953 A1
(43) Pub. Date: Dec. 29, 2016

(54) SMART FEED SYSTEM

(71) Applicant: Friends with Inspirations Ltd., Tortola (VG)

(72) Inventor: Ievgen Mashtakov, Warsaw (PL)

(21) Appl. No.: 14/846,973

(22) Filed: Sep. 7, 2015

Related U.S. Application Data
(60) Provisional application No. 62/184,842, filed on Jun. 25, 2015.

(51) Int. Cl. H04L 12/58; G06F 17/30

(52) U.S. Cl. CPC H04L 51/32; G06F 17/3053; G06F 17/30867

(57) ABSTRACT

A system for providing smart feeds to users, comprising a content curation server that receives content via a network and associates content with users, and provides content to a feed generator, a feed generator that produces feeds based on received content from a content curation server user associations, each feed being associated with a user, and an integration engine that receives feeds from a feed generator, adapts feeds for display, and provides feeds to network-connected software applications, and a method for providing a smart feed to a user.

### CROSS-REFERENCE TO RELATED APPLICATIONS

This application claims the benefit of, and priority to, U.S. provisional patent applications Ser. No. 62/184,842, titled “SMART FEED SYSTEM” and filed on Jun. 25, 2015, the entire specification of which is incorporated herein by reference in its entirety.

### BACKGROUND OF THE INVENTION

Field of the Art

The disclosure relates to the field of social networking, and more particularly to the field of real-time sharing of social experiences.

Discussion of the State of the Art

In the art of social networking, a “feed” generally displays a summary of content from various sources, such as comments, uploaded media, recent metadata “tag” activity, and other various social networking content. Content may optionally be sorted, for example by time or relevance. Content in a feed is generally selected according to direct user specification, such as choosing other users to follow or content types to include. There is currently no provision for adaptive or “smart” feeds, that may incorporate new content without explicit interaction from a user or that may update their content curation to remain relevant to a user's interests over time.

What is needed, is a means to automate a smart feed that selects and curates data based on up-to-date user activities and preference, using both explicit user preferences and inferred data to optimize presented content.

### SUMMARY OF THE INVENTION

Accordingly, the inventor has conceived and reduced to practice, in a preferred embodiment of the invention, a system for providing smart feeds to users, incorporating inferred data and automatic curation.

According to a preferred embodiment of the invention, a system for providing smart feeds to users, comprising a content curation server comprising at least a plurality of programming instructions stored in a memory and operating on a processor of a network-connected computing device and configured to receive a plurality of information content via a network, to generate a plurality of user associations based on at least a portion of the received content, and to provide at least a portion of received content to a feed generator; a feed generator comprising at least a plurality of programming instructions stored in a memory and operating on a processor of a network-connected computing device and configured to produce a plurality of feeds based at least in part on received content from a content curation server and based at least in part on a plurality of user associations, each feed being associated with a user, and configured to present feeds to an integration engine; and an integration engine comprising at least a plurality of programming instructions stored in a memory and operating on a processor of a network-connected computing device and configured to receive a plurality of feeds from a feed generator, and to adapt at least a portion of the plurality of feeds for display via a plurality of software applications via a network, and to provide at least a portion of the adapted feeds to a plurality of network-connected software applications, is disclosed.

According to another preferred embodiment of the invention, a method for providing a smart feed to a user, comprising the steps of configuring, at a content curation server comprising at least a plurality of programming instructions stored in a memory and operating on a processor of a network-connected computing device and configured to receive a plurality of information content via a network, to generate a plurality of user associations based on at least a portion of the received content, and to provide at least a portion of received content to a feed generator, a plurality of configuration preferences based at least in part on received user input; receiving a plurality of user-related information content; ranking at least a portion of the received content, the ranking being based at least in part on at least a portion of the plurality of configuration preferences; producing, using a feed generator comprising at least a plurality of programming instructions stored in a memory and operating on a processor of a network-connected computing device and configured to produce a plurality of feeds based at least in part on received content from a content curation server and based at least in part on a plurality of user associations, each feed being associated with a user, and configured to present feeds to an integration engine, a feed based at least in part on at least a portion of the ranked content and based at least in part on at least a portion of the plurality of configuration preferences; and presenting the feed for viewing by a user, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram illustrating an exemplary system for providing smart feeds, according to a preferred embodiment of the invention.

FIG. 6 is a flow diagram illustrating an exemplary method for providing a smart feed to a user, according to a preferred embodiment of the invention.

FIG. 7 is an illustration of a smart feed as it may be viewed by a user, according to an embodiment of the invention.

### DETAILED DESCRIPTION

The inventor has conceived, and reduced to practice, in a preferred embodiment of the invention, a system for providing smart feeds to users, incorporating inferred data and automatic curation.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

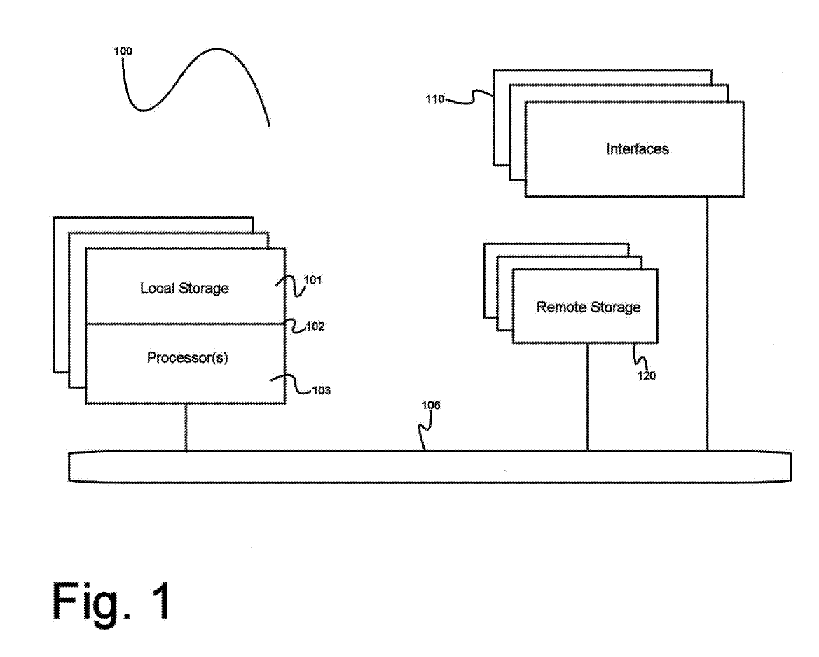

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software-or hardware-based instructions according to one or more programs stored in memory. Computing device 100 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

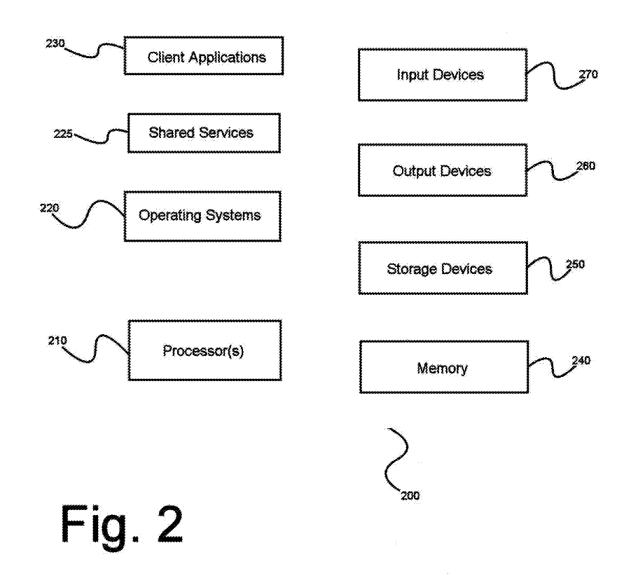

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

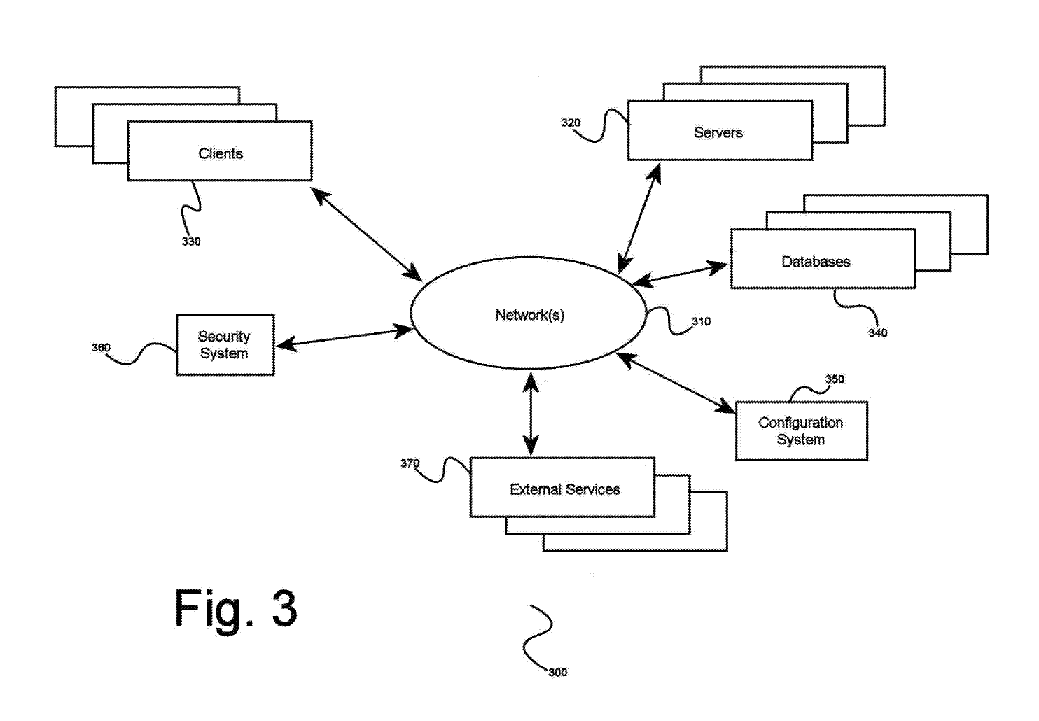

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

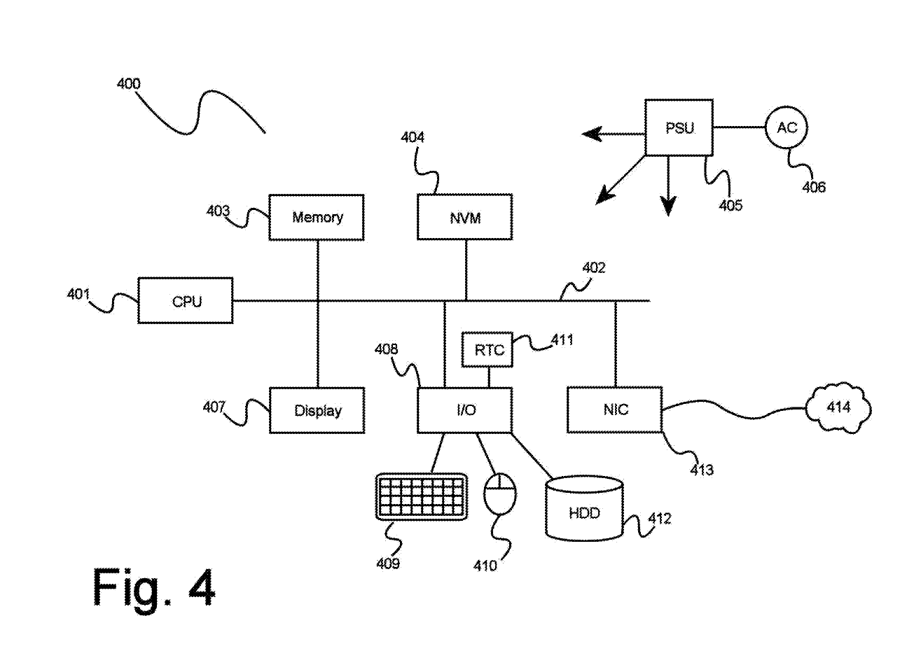

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

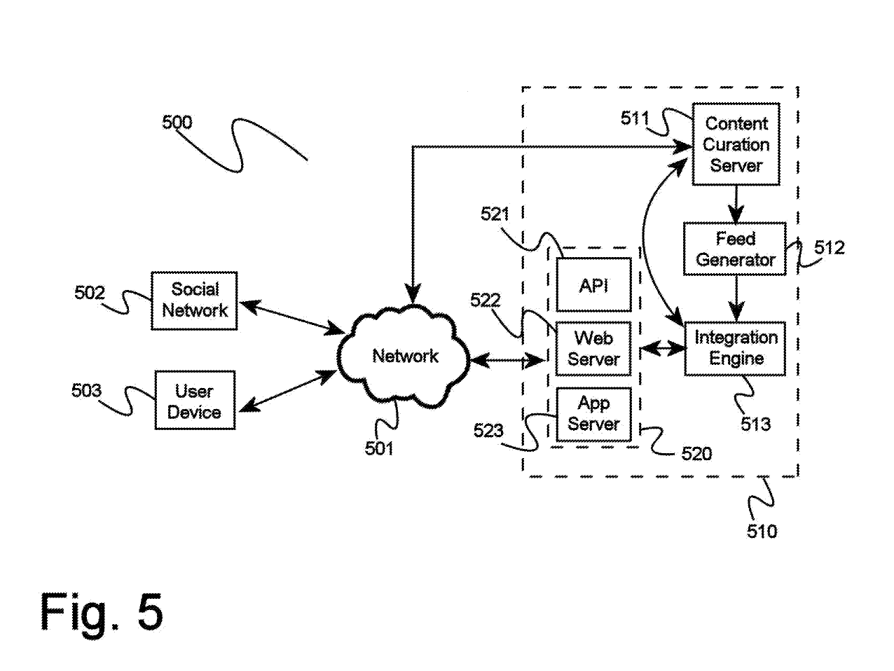

FIG. 5 is a block diagram illustrating an exemplary system 500 for providing smart feeds, according to a preferred embodiment of the invention. According to the embodiment, a smart feed system 510 may comprise a content curation server 511 comprising at least a plurality of programming instructions stored in a memory and operating on a processor of a computing device and configured to receive a plurality of information content via a network 501 (such as the Internet or any other suitable data communication network), to generate a plurality of user associations based on at least a portion of the received content, and to provide at least a portion of received content to a feed generator 512. Content curation server 511 may receive a variety of user-based information content, for example including (but not limited to) social network activity such as posts or “likes”, e-commerce activity such as product purchases or reviews, browsing activity, device information, personal information such as contact or location information, or any other such information that may be associated with, or used to identify, an individual user. This content may then be provided to a feed generator 512 for use in producing a curated user-specific feed.

Further according to the embodiment, a feed generator 512 may be used and may comprise at least a plurality of programming instructions stored in a memory and operating on a processor of a computing device and configured to produce a plurality of feeds based at least in part on received content from a content curation server 511 and based at least in part on a plurality of user associations, each feed being associated with a user, and configured to present feeds to an integration engine 513. For example, feed generator 512 may receive a plurality of e-commerce data such as product purchase records, and may associate these purchases with particular users that made them, so that each user's feed may now include their purchase history (and exclude any purchases made by other users). In this manner, a feed generator 512 may be used both for the creation of user-specific feeds and for enforcing information boundaries, preventing information for one user from appearing in the feed of another.

Further according to the embodiment, an integration engine 513 may be used, and may comprise at least a plurality of programming instructions stored in a memory and operating on a processor of a network-connected computing device and configured to receive a plurality of feeds from a feed generator, and to adapt at least a portion of the plurality of feeds for display via a plurality of software applications via a network 501, and to provide at least a portion of the adapted feeds to a plurality of network-connected software applications. For example, integration engine 513 may operate a variety of software or hardware-based communication adapters 520 to facilitate communication with network-connected software applications or devices, for example a software application programming interface (API) 521 may be used to communicate with software applications or service such as a social network 502, a web server 522 may be used to communicate via a web interface accessible via a web browser operating on a user's device 503, or an application server 523 may be used to communicate via a software application operating on a user's device 523 (for example, an app operating on a smartphone). It should be appreciated that a variety of additional or alternate communication adapters may be utilized according to a particular arrangement.

In an exemplary use case, a user may configure smart feed access to various social network accounts (such as TWITTER™ or FACEBOOK™) or e-commerce marketplaces or vendors (such as AMAZON™ or EBAY™), for example, by submitting their smart feed account information via a “link your account” or similar prompt with each network or marketplace. After linking their smart feed profile, activity within configured networks or marketplaces may be tracked and incorporated into a smart feed for the user, by incorporating activity data via a content curation server 511 optionally via an integration engine 513 (as may be needed according to a particular arrangement or according to the nature of a particular configured service or application). For example, a user's purchases in an online marketplace may be tracked to determine what sort of products they are interested in, or to track their submitted reviews to determine their level of interest, satisfaction, or sentiment with various products or vendors. Their social network activity may be tracked and used to determine what topics, groups, or users they may be interested in, or what types of content they may enjoy (such as by monitoring their “reblog” or “like” activity, for example when a user “likes” a video of a particular topic or from a particular user). In this manner a user's activity may be tracked and incorporated to maintain relevancy within a smart feed, and a user may be given a degree of control over what content they wish to expose to a smart feed system.

### Detailed Description of Exemplary Embodiments

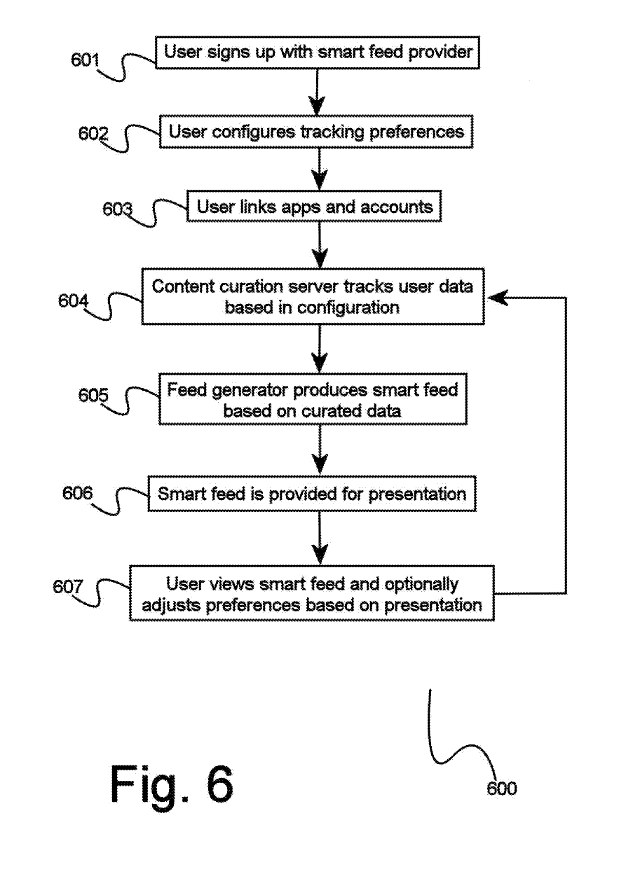

FIG. 6 is a flow diagram illustrating an exemplary method 600 for providing a smart feed to a user, according to a preferred embodiment of the invention. In an initial step 601, a user may sign up for an account with a provider of a smart feed service (such as a social network operator that has incorporated smart feed functionality into their service, or a provider for standalone smart feed operation for integration into third-party products and services). In a next step 602, a user may configure a variety of tracking preferences, such as what types of activity they want to be monitored for inclusion in a smart feed (for example, “Do not track purchase information”), or what priority to give certain types or categories of information such as selecting a number of interests to rank higher than others, so that a user may configure what information they are presented in a smart feed, to suit their personal tastes.

In a next step 603, a user may link a number of external account or software applications or services, for example by providing their user account information to a smart feed provider or conversely providing their smart feed user information to a service provider. For example, a user might utilize an integrated “link your smart feed account” functionality provided by a social networking service to give a smart feed access to their activity within the social network, or they might provide a smart feed provider with their account information for an e-commerce marketplace such as AMAZON™ to enable tracking of purchases or reviews within that marketplace. In this manner a user may be given explicit control over what sort of information they do or do not wish to expose to tracking.

In a next step 604, a content curation server may track a user's activity according to configured preferences, for example by monitoring browser activity, social network posts (or other activity such as “likes” or comments on other users' content), e-commerce purchases or reviews, or software application usage such as what types of apps they use and for how long, or app-specific activity such as gaming statistics (as might be provided by a videogame or other gaming-oriented application such as STEAM™, for example) or media playback information as might be reported by a media player such as ITUNES™ or XBOX MUSIC™, for example.

In a next step 605, a feed generator may incorporate any of a plurality of curated data associated with the user, and may produce a feed for presentation based on the curated data as well as any configured preferences that may affect presentation, such as configured information priority or categorization information, or a user's configured display preferences or device capabilities (for example, content may be rearranged or resized to fit various display types or sizes, such as when a user views a smart feed on a smartphone). In a next step 606, this produced smart feed may then be provided for presentation, for example via an integration server to present the smart feed as an embedded or integrated component within a software application or a web interface, for example to display a smart feed alongside a user's social network interface.

In a final step 607, a user may view content in their smart feed and optionally interact with content (such as by commenting on images presented, listening to audio content or viewing video content), or they may optionally adjust their configuration preferences according to the nature of the feed as it was presented. For example, a user may decide that the information presented was biased in favor of a particular product category and they wish to change the ranking for product purchases. Operation may continue as illustrated, with a content curation server continually updating information according to new activity or configuration changes, and a feed generator continually updating the feed for presentation based on any changes to curated data or user preferences. In this manner, a smart feed may be kept continually relevant and “up to date” for a user, always reflecting their most recent preference and activity information.

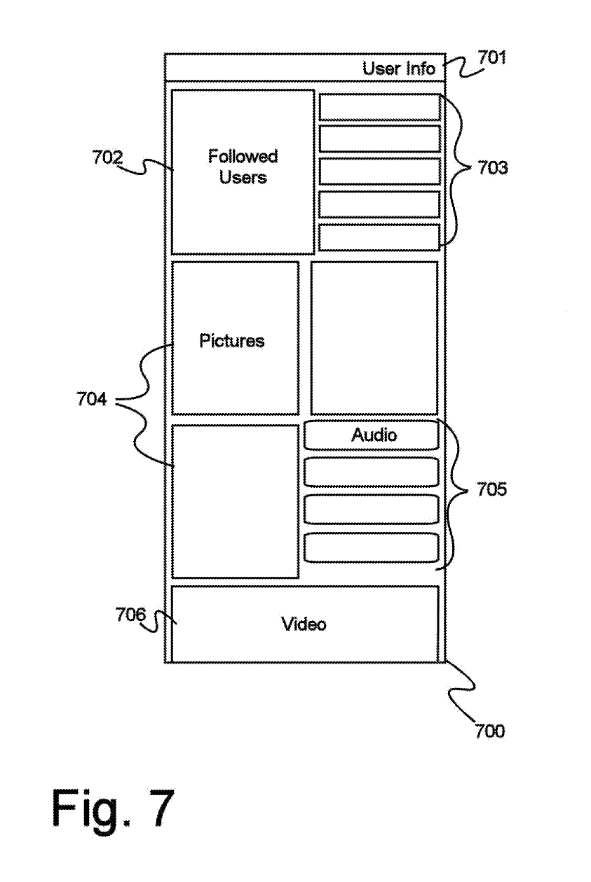

FIG. 7 is an illustration of a smart feed 700 as it may be viewed by a user, according to an embodiment of the invention. According to the embodiment, a smart feed 700 may display a user's name or other personal identification information 701, identifying what user is currently logged in and being tracked and for whom content is being curated and displayed (as may be useful on a shared computer, for example, to ensure the viewer can readily identify whether the information presented is relevant to them or not). A plurality of social network data may be displayed, such as users being “followed” 702, optionally with interactive elements 703 to enable a user viewing the feed to comment on a social network, for example by posting a comment on another user's profile, or by sending a private message to another user. A plurality of images 704 may be presented, such as photos uploaded by a followed user on a social network, product images from recent purchases, or images from advertisements relevant to a user's curated content such as products related to those recently reviewed or purchased, or photos with similar content (as may be identified from embedded metadata or user tags associated with an image) to those a user has “liked” on a social network. A plurality of audio content 705 may be presented, such as audio tracks uploaded by a followed user on a social network (for example, new songs from a favorite artist on SOUNDLCOUD™), and may optionally be interactive so that a user may listen to audio directly from a smart feed without having to open a separate browser or application window, and a plurality of video content 706 may be presented, for example video uploads from other users on a social network such as new posts from a followed user on YOUTUBE™. In this manner it can be appreciated that a wide variety of content may be presented to a user, and that the nature of a smart feed may vary according to the content being presented such as by adding or removing interactive elements as appropriate, or rearranging presented content according to a user's preference or according to curation results (for example, less-relevant or lower-ranked content may be placed visually further down in a feed, while higher-ranked or more relevant content may be presented nearer to the top, where a user is most likely to see or act on the content). It should be appreciated that the particular nature or arrangement of content described and illustrated is exemplary, and may vary widely.

According to the embodiments, a “smart feed” is a feed that may be enhanced by prioritizing content according to a user's current interests (showing a user “what they really care about”). A user may decide what they like, comment, follow, share, or what type of content they prefer (for example, some users may enjoy viewing image-based content, while others may prefer audio). These choices may be used to create a unique user profile or record, identifying a user's particular preferences and interests. These user profile may be consulted when selecting content for presentation in a feed, or while determining how to present content (for example, while sorting or categorizing content for display to a user). Additionally, an algorithmic approach may be utilized to show users preferred content, for example implementing artificial intelligence and “big data analysis”.

User interactions and activities may affect their smart feed, for example if a user watches several videos posted by a particular individual or group, future postings from that individual or group may be given a higher relevance when determining if or how to present them to a user. A smart feed may also identify whether a user is currently logged in, and may use this user availability information to configure operation.

A user that is not logged in, or that may not have a registered account on a smart feed service (for example, any social networking service or software application that is configured to utilize a smart feed according to the embodiment), may still benefit from a variety of smart feed capabilities. For example, web activity tracking may be used to identify websites a user visits often or has visited recently, activity patterns may be tracked such as preferred audio or video content or frequently-played games, or browser “cookies” may be used to enable user-specific tracking capabilities. In this manner, an unknown user may still benefit from a more personalized content presentation, for example when viewing a smart feed on a webpage (for example, if a webpage has a smart feed configured that is visible to all visitors, regardless of their account status), or if they register or log in at a future time (that is, activity while logged out may still affect a smart feed presented when the user logs back in).

When logged in, a user may be more accurately tracked to enable greater personalization. User-specific history and activity may be monitored, and a user may be able to configure specific operation such as to exclude specific history or activities, for example to explicitly declare that they have lost interest in a topic and no longer wish it to be displayed in a smart feed. While logged in, a user's smart feed may be updated in real-time with their most up-to-date interests or activities, ensuring the most immediately relevant content is always available.

Smart feed presentation may be configured to operate on a weighted system, for example by giving preference to particular content types or tracking data. For example, history while logged in may be given preference (for example, when determining relevance of content based on tracking) over history while logged out. Additionally, manually-configured preferences (such as when a user specifically excludes certain types of content or tracking, as described above) may be given priority over those determined automatically or through machine learning, allowing a user to override automated behavior as needed. Such weighted ranking of content may factor in user activities such as “likes” via a social network application or service, indicating a user favors a particular content item or type, copies such as reposting via a social network application or service, indicating that a user is promoting a particular content item or type, or time-based ranking such as to identify that a user may have lost interest in content that has not had any activity within a configured timeframe. Ranking may also comprise multiple separate ranking factors such as sentiment that may describe like or repost ranking, as well as recentness that may separately describe time-based data, each of which may optionally have additional factors such as “last time user reposted” or “last time user viewed” (according to a time-based ranking factor), and these ranking factors may be algorithmically processed to arrive at a final ranking value for any particular content item or type, or for a content collection as described below. In this manner operation may vary in granularity according to a particular arrangement or use case, and such operation may optionally be configurable by a user to enable users to set preferences to tailor their smart feed to suit their specific preference (for example, a user may specify, “If I haven't viewed this within the last week, it is no longer relevant”, or other such specific configuration). Additionally, a user location or device may be used as a ranking factor, for example to select content to display to a user based on the device they are using to interact with a smart feed (for example, showing relevant apps when a user is on a smartphone, or relevant movies when they are viewing via a smart television), or to display content based on a user's geographic or network location, such as to display nearby restaurants according to known food preference (optionally also considering time of day, for example to select breakfast or dinner-specific restaurant types), or to display nearby tourist attractions if a user is on a hotel's network (for example). It may be appreciated that various ranking factors may be combined in this manner to provide highly-personal and relevant content to a user at all times, by taking into consideration all available data and rapidly reprocessing content for display according to what may be most immediately-relevant to a user.

Smart feed selection or arrangement may make use of content collections, or groups of associated content that may be treated collectively during smart feed operation for a given user.

For example, if a user has specified that they like fishing equipment, various product listings or reviews for fishing equipment may be grouped together into a single collection for easier processing as a unit, rather than processing each item individually. Such an arrangement may improve responsiveness during operation as well as relevance of content, for example by incorporating metadata to identify content rapidly by tags to group into collections for presentation to a user.

An additional ranking factor (as described above) may consider content origin, such as a user account on a social network that posted a review or image. By considering the source of content, additional ranking factors may be exposed such as trustworthiness or sentiment, reflecting how a smart feed user may view a particular content source. For example, a user may choose to distrust content form a particular source based on personal experience, or to avoid content form a source based on personal or professional objections to the content's source, regardless of the nature of content itself. For example, a user may wish to block all content from a particular website, regardless of the content's nature, ensuring that even if that site posts something that might be considered relevant to their interests, it is ignored (thus providing an effective spam filter functionality, filtering out content sources that may be relatively useless or undesirable but ostensibly claim to provide content relevant to a user's interests).

The skilled person will be aware of a range of possible modifications of the various embodiments described above. Accordingly, the present invention is defined by the claims and their equivalents.

What is claimed is:

1. A system for providing smart feeds to users, comprising:
a content curation server comprising at least a plurality of programming instructions stored in a memory and operating on a processor of a network-connected computing device and configured to receive a plurality of information content via a network, to generate a plurality of user associations based on at least a portion of the received content, and to provide at least a portion of received content to a feed generator;
a feed generator comprising at least a plurality of programming instructions stored in a memory and operating on a processor of a network-connected computing device and configured to produce a plurality of feeds based at least in part on received content from a content curation server and based at least in part on a plurality of user associations, each feed being associated with a user, and configured to present feeds to an integration engine; and
an integration engine comprising at least a plurality of programming instructions stored in a memory and operating on a processor of a network-connected computing device and configured to receive a plurality of feeds from a feed generator, and to adapt at least a portion of the plurality of feeds for display via a plurality of software applications via a network, and to provide at least a portion of the adapted feeds to a plurality of network-connected software applications.

2. The system of claim 1, wherein the plurality of network-connected software applications comprise at least a web interface operated by a social network.

3. The system of claim 1, wherein the plurality of network-connected software applications comprise at least a software application operating on a user's mobile device.

4. The system of claim 1, wherein the integration engine receives a plurality of information content via a network, and provides the received information content to a content curation engine.

5. A method for providing a smart feed to a user, comprising the steps of:
configuring, at a content curation server comprising at least a plurality of programming instructions stored in a memory and operating on a processor of a network-connected computing device and configured to receive a plurality of information content via a network, to generate a plurality of user associations based on at least a portion of the received content, and to provide at least a portion of received content to a feed generator, a plurality of configuration preferences based at least in part on received user input;
receiving a plurality of user-related information content;
ranking at least a portion of the received content, the ranking being based at least in part on at least a portion of the plurality of configuration preferences;
producing, using a feed generator comprising at least a plurality of programming instructions stored in a memory and operating on a processor of a network-connected computing device and configured to produce a plurality of feeds based at least in part on received content from a content curation server and based at least in part on a plurality of user associations, each feed being associated with a user, and configured to present feeds to an integration engine, a feed based at least in part on at least a portion of the ranked content and based at least in part on at least a portion of the plurality of configuration preferences; and
presenting the feed for viewing by a user.

6. The method of claim 5, further comprising the step of adapting, using an integration engine comprising at least a plurality of programming instructions stored in a memory and operating on a processor of a network-connected computing device and configured to receive a plurality of feeds from a feed generator, and to adapt at least a portion of the plurality of feeds for display via a plurality of software applications via a network, and to provide at least a portion of the adapted feeds to a plurality of network-connected software applications, the feed for presentation within a software application.
